(19) United States
(12) Patent Application Publication
(10) Pub. No.: US 2026/0139976 A1
(43) Pub. Date: May 21, 2026

(54) Closure Element for a Bore with an Electric Element

(71) Applicant: SFC Koenig AG, Dietikon (CH)

(72) Inventors: Luca Lorenzelli, Dietikon (CH); Manfred Pister, Dietikon (CH); Jetmir Selimaj, Dietikon (CH)

(21) Appl. No.: 19/118,377

(22) PCT Filed: Oct. 9, 2023
(86) PCT No.: PCT/EP2023/077943

§ 371 Date: Apr. 4, 2025

(30) Foreign Application Priority Data
Oct. 7, 2022 (EP) 22200329.5

(51) Int. Cl. G01D 11/30; G01K 1/08; G01K 1/14; G01L 19/14

(52) U.S. Cl. CPC G01D 11/30; G01K 1/08; G01K 1/14; G01L 19/14

(57) ABSTRACT

A closure or fastening element for inserting into a bore in a component includes a base body insertable into the bore, a splaying body having an internal opening along the longitudinal axis of the closure element, a tension bolt, connected to the splaying body, and an electric element arranged at least partly in the opening of the splaying body. The electric element is configured to transmit and/or receive electric signals, wherein the splaying body braces the base body in the fitted state in said bore. The internal opening is provided with its outlet towards the upper surface in the splaying body.

### CROSS-REFERENCE TO RELATED APPLICATIONS

This application is the United States national phase of International Patent Application No. PCT/EP2023/077943 filed Oct. 9, 2023, and claims priority to European Patent Application No. 22200329.5 filed Oct. 7, 2022, the disclosures of which are hereby incorporated by reference in their entireties.

### BACKGROUND OF THE INVENTION

### Field of the Invention

The present invention relates to a closure or fastening element for inserting into a bore in a component, comprising a base body insertable into the bore, a splaying body having an internal opening, a tension bolt, connected to the splaying body, an electric element arranged at least partly in the opening of the splaying body, wherein the electric element is configured to transmit and/or receive electric signals, wherein the splaying body braces the base body in the fitted state.

### Description of Prior Art

Such closure or fastening elements for inserting into a bore, for example, in an engine, with a sleeve-shaped base body that can be inserted into the bore and with a splaying body that can be braced in the bore are known. Closure elements of this type are inserted, in particular as mass-produced items, into bores with different diameters and internal pressures for the purpose of sealing.

Providing an electric element in such a closure element is known from U.S. Pat. No. 9,689,718 B2 of the applicant. This closure element is to be inserted into a bore in a component, such as into a bore in an engine, a valve block, a hydraulic unit or a container. At least one electric element which is arranged in or on the element is provided, wherein each electric element transmits and/or receives electric signals. In the fitted state, the electric element is advantageously positioned such that the electric element is adjacent to the chamber formed in the bore and is therefore in contact, for measuring purposes or the like, with the medium contained in the bore. In addition to the actual sealing and/or fastening function, the element can therefore be used to undertake one or more measurements. Depending on the electric element used, the closure element is a housing for sensors.

### SUMMARY OF THE INVENTION

It is an object of the present invention to improve the usability of such electric elements in closure elements.

Based on the above-mentioned prior art such an increase of usability of a closure or fastening element is achieved with the features of the closure element described herein.

Such a closure or fastening element for inserting into a bore in a component comprises a base body insertable into the bore, a splaying body having an internal opening along the longitudinal axis of the closure element, a tension bolt connected to the splaying body, as well as an electric element arranged at least partly in the opening of the splaying body. The electric element is configured to transmit and/or receive electric signals, wherein the splaying body braces the base body in the fitted state in said bore. The internal opening is provided with its outlet towards the upper surface in the splaying body and there is an installation element provided on the tension bolt configured to be connected to an installation tool for pulling the splaying body back into the base body for fixation of the closure element in said bore.

The tension bolt is connected in one piece to the splaying body. Therefore, it can also be stated that the splaying body comprises the head, which is the actual splaying element, and said tension bolt without providing a clarity issue.

The internal opening can be a through bore, the electric element can be provided inside a housing and the housing is positioned, especially glued or injection moulded, in the internal opening near the underside of the splaying body.

The through bore can have a connecting cavity and a sensor cavity wherein the sensor cavity has a larger diameter to accommodate the housing of the electric element against the shoulder between connecting cavity and sensor cavity. Such a shoulder improves the tightness of the sealing effect of the housing in the cavity.

Said housing can comprise one or more circumferential grooves to accommodate sealing rings.

The closure element can comprise two or more electric connections, e.g. wires connected with the electric element and extending beyond the outlet of the internal opening for an external connection with a controller.

The electric connections can be provided within a cable, especially a shielded cable. The cable can already comprise a plug at the end opposite to the electric element for connecting a controller.

The electric element can comprise a transceiver for wireless communication.

A further closure element has an electric element comprising a transceiver for wireless communication. The internal opening can comprise a connecting cavity and a sensor cavity wherein the sensor cavity near the underside of the splaying body accommodates the housing of the electric element and the connecting cavity at the opposite side of the splaying body is separated from the sensor cavity by a signal transfer area within the splaying body adapted to allow a wireless signal transfer through the signal transfer area and the connecting cavity. Then the sensor cavity is physically separated from the connecting cavity and thus from the outer environment.

The electric element can then comprise a NFC transceiver, wherein a further NFC transceiver is positioned in the connecting cavity.

The electric element for the wireless transceiver can comprise a battery as energy source, instead of relying on induction based energy transfer.

The electric element can comprise one or more sensors, especially a temperature sensor and/or a pressure sensor.

The closure element can have the outlet of the internal opening being oriented towards the upper surface of the tension bolt beyond the installation element of the splaying body.

Specifically, the installation element can be an installation groove.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a section of a pre-assembled closure element for contactless sensing of a fluid;

FIG. 2 shows the detail area II of FIG. 1;

FIG. 3 shows a section of a further pre-assembled closure element for contactless sensing of a fluid;

FIG. 4 shows a section of the pre-assembled closure element of FIG. 3 with sensor and cable connections;

FIG. 5 shows a section of a pre-assembled closure element for sensing in contact with a fluid;

FIG. 6 shows a section of the closure element of FIG. 5 in an built-in state without the component;

FIG. 7 shows a section of the closure element of FIG. 6 in a bore in the component;

FIG. 8 shows a section of the closure element of FIG. 6 in an built-in state with the electric element and electric connections;

FIG. 9 shows a section of the closure element of FIG. 8 in a bore in the component;

FIG. 10 shows a section of a further pre-assembled closure element for sensing in contact with a fluid;

FIG. 11 shows a section of the closure element of FIG. 10 with sensor and cable connections;

FIG. 12 shows a section of a further pre-assembled closure element for sensing in contact with a fluid for wireless communication; and

FIG. 13 shows a section of the closure element of FIG. 12 with the sensor.

### DESCRIPTION OF THE INVENTION

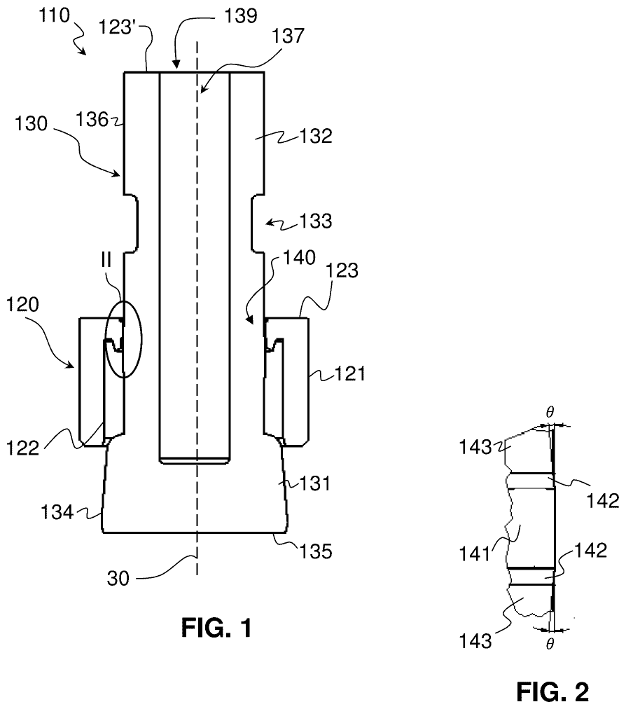

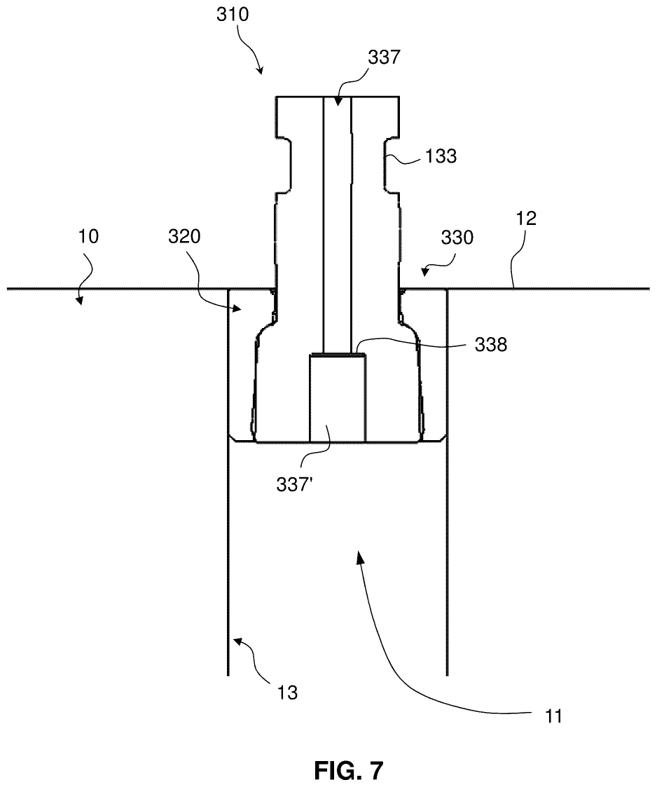

FIG. 1 shows an element 110 which serves as a closure element for inserting into a bore 11 in a component 10 as shown in FIG. 7. The component 10 can be inter alia an engine, a valve block, a hydraulic unit or a container.

The closure element 110 is made in one piece and is made up of a sleeve-shaped base body 120 that can be inserted into the bore 11 and the outer circumference 121 of which in the installed state lies tight against the inner surface of the bore 11, and of a splaying body 130 that can brace this base body 120 in the bore 11.

The splaying body 130 comprises a head 131 and a tension bolt 132. The tension bolt 132 comprises an installation element, here an installation groove 133 which is adapted to be gripped by a complementary installation clamp to hold the tension bolt 132, especially in a form closure or form fit to be able to pull the tension bolt 132 in its longitudinal direction to insert and brace the splaying body 130 in the base body 120. In other words, the drawings show one part of the installation unit comprising the installation groove and a clamping tool.

The head 131 has a full flat underside 135 and a conical outer head surface 134 which is adapted to lie tied against the inner surface 122 of the base body 120 in the assembled state. The installation groove 133 is provided in an area of the splaying body 130 which is in the preassembled state positioned above the upper flat surface 123 of the base body 120.

The installation element 133 as part of an installation unit can be in other embodiments a bayonet mount comprising a bayonet closure groove in the splaying body 130 as female receptor, wherein the installation tool comprises the male side with one or radial pins engaging the bayonet female receptor. It can also be a thread connector with an outer thread on the splaying body and an inner thread on the installation tool.

The common feature of the installation element is being a part of a two part installation unit adapted to exert a pull force on the splaying body 130 in its longitudinal direction and being amovible.

The splaying body 130 and the base body 120 put over the latter can be positioned together in the bore 11. By means of a force applied to the tension bolt 132 and to the splaying body 130 away from the component 10 it can be pushed into the base body 120 so that the splaying body 130 presses the outer surface 121 of the base body 120 tightly against the wall of the bore 11 to be closed by generating a radial pressure on the inner wall 122 of the base body 120.

The tension bolt 132 has a central cavity 137 going beyond the installation groove area 133 into the head 131. Central cavity 137 forms a blind hole. With reference to FIG. 4 it will be described that an electric element in a housing 20 of the electric element is positioned at the bottom surface 138 of this cavity 137.

FIG. 2 shows the detail area II of FIG. 1 as part of the base body 120 facing the splaying body 130. The sleeve shaped base body 120 has a head-receiving larger internal opening with inner surface 122 to accommodate the head 131 of the splaying body 130 as well as a bolt-part-receiving internal opening 140 with three adjacent portions 143, 141 and 143 seen from the upper surface 123 of the base body 120. The middle portion 141 has a cylindrical surface configured to meet the outer surface 136 of the bolt portion of the head 131 below the installation groove area 133 as guide allowing for a preassembly of the closure element as shown in FIG. 1 (plus the electric element 20). A slanting angle conical section 142 is provided on both sides adjacent to the middle portion 141 followed by an outer portion 143. The small angle Θ shown in FIG. 2 with a possible value between 1 and 10 degrees, preferably between 3 and 7 degrees and especially 5 degrees is related to the conical section 142 connecting the two cylindrical sections of smaller inner diameter 141 to another cylindrical section of larger inner diameter 143. These section shown in FIG. 2 are only needed for pre-assembly purposes. The wording smaller diameter section 141 is related to the inner diameter of the hollow cylindrical section 141 which has a smaller inner diameter than the two outer sections 143, having a larger inner diameter and thus being able to accept the splaying body 130 more easily.

An electric element is positioned in a housing 20 in the internal cavity 137 disposed in the hollow splaying body 130 as shown for a similar embodiment shown in FIG. 4. It transmits and/or receives electric signals via (at least) two electric connections 23 and is held, preferably with form fit, in the interior of the splaying body 130. The form fit of the housing 20 allows for an electric element 21 in the housing not to experience direct pressure which is essentially absorbed by the housing 20.

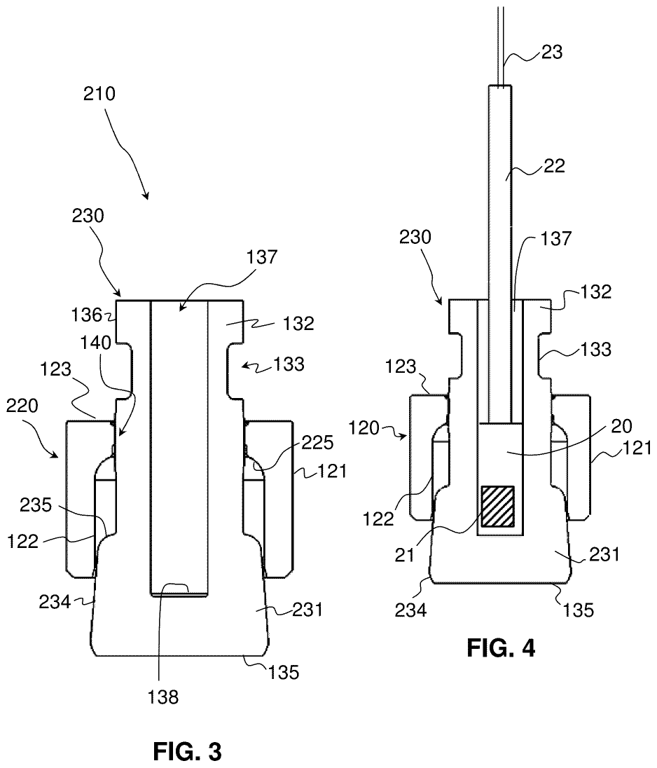

FIG. 3 shows a section of a further pre-assembled closure element 210 for contactless sensing of a fluid. This embodiment is similar to the embodiment of FIG. 1, so only the different features receive different numerals as base body 220 and splaying body 230, whereas elements as the tension bolt 132 with its installation groove area 133 still receive the reference numerals from the first embodiment. The main differences are in the complementary form of head 231 and base body inner surface. The outer head surface 234 has a rounded tapered area 235 towards the outer surface 136 of tension bolt 132. This rounded tapered area 235 abuts in the assembled state against the complementary surface 225 of the base body 220. The area of inner opening 140 can be built as shown in FIG. 2.

FIG. 4 shows a section of the pre-assembled closure element 210 of FIG. 3 with sensor and cable connections. The housing 20 of electric element 21 (shown as insert in housing 20) is a sensor having here two electric connections 23 shown as part of cable 22. Housing 20 is positioned and can be glued at the bottom of the cavity 137.

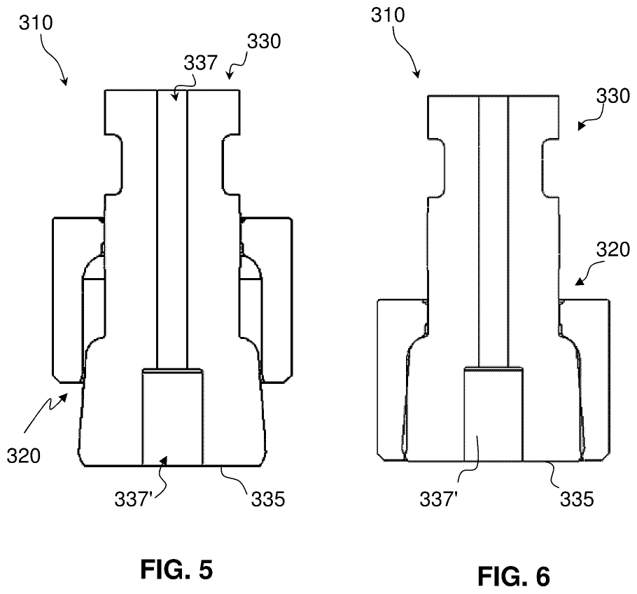

FIG. 5 shows a section of a pre-assembled closure element 310 for sensing in contact with a fluid being in the depth of the bore beyond the closure element 310, FIG. 6 shows a section of the closure element 310 of FIG. 5 in an built-in state without the component 10 and FIG. 7 shows a section of the closure element 310 of FIG. 6 in a bore 11 in the component 10.

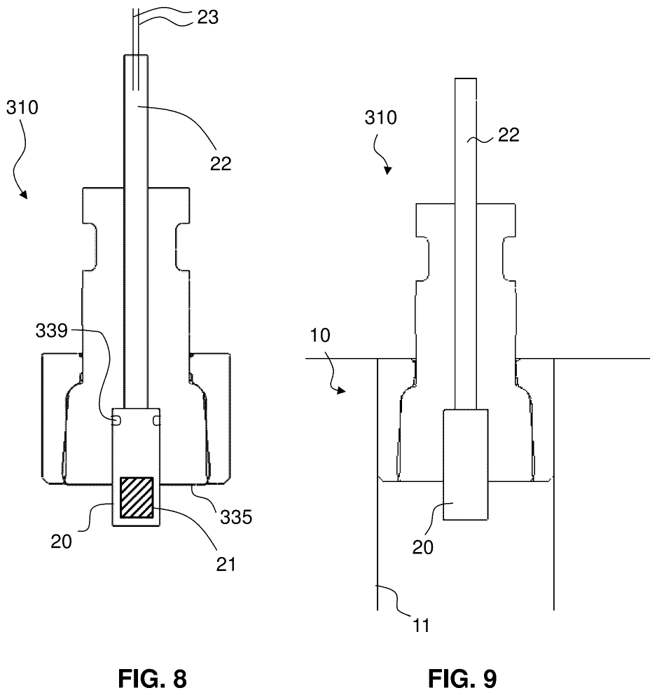

The closure element 310 comprises a base body 320 and a splaying body 330 which are built and interact as in the above mentioned embodiments. The cavity in the splaying body 330 is a through bore with a sensor cavity 337′ opening at the underside 335 in the bore and a connecting cavity 337 towards the installation groove area 133. The connecting cavity 337 has a smaller diameter so that a shoulder 338 appears at the transition to the sensor cavity 337′. The electric element can be fixedly positioned in the sensor cavity 337′, especially if it is protected by a housing 20. This embodiment enables the direct contact between the electric element 21, especially a sensor and the fluid in the bore 11 with the electric connections being going beyond the connecting cavity 337 as shown in FIGS. 8 and 9.

FIG. 8 shows a section of the closure element 310 of FIG. 6 in an built-in state with the housing 20 of the electric element 21 and electric connections 23. The electric connections 23 are running inside cable 22 which might have almost the diameter of the opening cavity 337. The cable 22 can be shielded. Here, part of the housing 20 of the electric element 21 (and the electric element 21 as well) is extending beyond the underside 335 of the splaying body 330. FIG. 9 shows a section of the closure element 310 of FIG. 8 in a bore 11 in the component 10 with the housing 20 of the electric element 21 is extending beyond the underside 335 into the fluid in the bore 11. In the fitted state, the electric element 21 is positioned such that it is adjacent to the cavity formed in the bore 11, and so is in contact with the medium contained in the bore for measuring purposes or the like.

This electric element 21, illustrated diagrammatically here, can also be made in the form of a plate or in some other form, and its electric connections 23 can be provided in different numbers, especially more than two, or arranged differently than shown.

Depending on the application, a sensor, an actuator, a transducer, a chip, a measuring converter or the like can be used for the electric element 21. For example, the pressure and/or the temperature of the medium in an engine block as a component 10 can be determined permanently or by controlled retrieval.

An O-ring 339 is schematically shown inside a circumferential groove in the housing 20 pressing onto the hollow cylindrical wall of sensor cavity 337′ for an extended sealing function of the housing 20. Of course, there can be provided two or more O-rings 339.

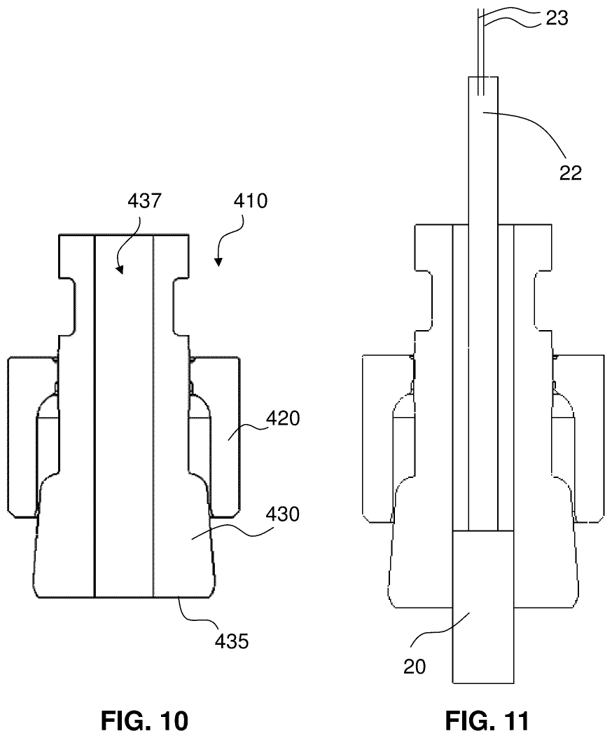

FIG. 10 shows a section of a further pre-assembled closure element 410 for sensing in contact with a fluid. FIG. 11 shows a section of the closure element 410 of FIG. 10 with electric element 20 and cable connections 22. The difference between the embodiment of FIG. 10 and the embodiment of FIG. 5 to 9 lies in the through bore and connecting and sensor cavity 437 which has an identical cross-section along the longitudinal axis of the cavity. Fig-10 shows the preassembled state without the housing 20 of the electric element, while FIG. 11 shows the introduction of especially a housing 20 of the electric element. When the closure element 410 is fitted together in a bore, then the splaying body 430 is inserted into the base body 420. This exerts a radial pressure also on the housing 20 of the electric element 21 which then withstands any fluid pressure from the inside of the bore.

In order to prevent sensor damaging, the cavity sealing can already be done by the sensor cage or embedding structure. Such an embedding structure can be provided by plastic injection molding of the electric element 21 with the cable 23 into the base body 430. The electric element 21 (which may include a (smaller than the cavity) sensor housing 20) is positioned in the base body 430. When the electric element 21 comprises a wire based transmission connection, then the cable 22 is also positioned in the base body 430. Then this preassembled element is positioned in an injection molding apparatus and the cavity 337 and 337′ or 437 are at least partly filled with an injection material to seal the bore. Injection moulding can also be used in the positioning of electric elements 21 in the embodiments with cavity 137 or 537′. In view of a more secure preassembly, the housing 20 can also initially glued in the cavity 437 and it may also comprise the groove with the O-ring 339 or another sealing element.

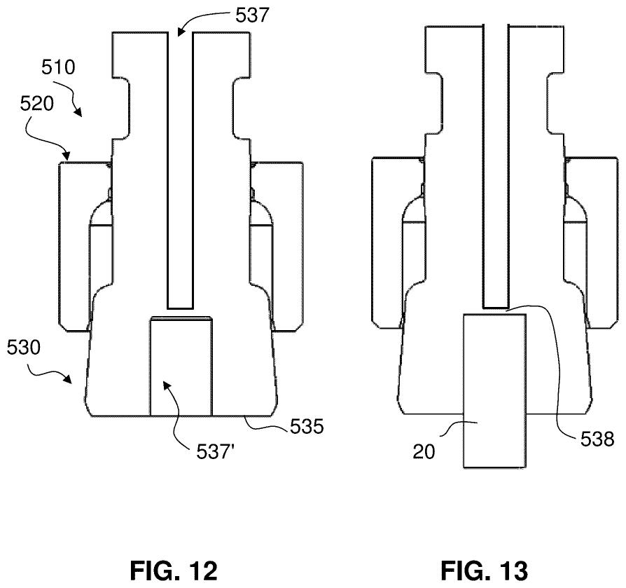

FIG. 12 shows a section of a further pre-assembled closure element 510 for sensing in contact with a fluid for wireless communication and FIG. 13 shows a section of the closure element 510 of FIG. 12 with the housing 20 of the electronic element 21. The splaying body 530 within this embodiment has a sensor cavity 537′ exclusively in the underside 535 of the splaying body 530, in which the housing 20 of the electronic element 21 is fixated. The electronic element 21 is configured to have a wireless connection with an outside controller (not shown) as the previous electric elements 20 were connected with the electric connections 23 with such a controller. The sensor cavity 537′ in the splaying body 530 is provided for a measuring in a distance from the bore 11 through on blind hole cavity 537 opening in the upper surface of the splaying body 530. There is a small distance in the splaying body 530 between the bottom of the blind hole cavity 537 and the inside wall of the sensor cavity 537′ allowing for a wireless transmission since the small distance between the two cavities 537 and 537′ is thin enough to reduce the effect of Faraday of the aluminum material making up the 538.

The closure element 10 can comprise a base body positioned in a graduated bore 11 and a separate sleeve-shaped splaying body 530 that can be pushed into said base body 520. Said splaying body 530 is pushed in in such a way that the base body 520 is pressed radially outwards against the inner wall of the bore 11 and is pushed in with its projecting annular outer ribs or the like into the material of the bore wall with plastic deformation for reliable holding and sealing.

The housing 20 of the electric element 21 is disposed in the base body 530 which is advantageously also in the shape of a sleeve so that the electric element 20 fastened in the latter can, as it were, be in contact with the medium located in the bore. The lower opening of the base body can be preferably provided with a funnel shape so that the electric element 20 is advantageously exposed to the medium over its entire lower side.

As one feature, provision is also made such that the electric element 21 performs a sealing function for this closure element because both the splaying and the base body are made in the form of a sleeve. One is thus offered the advantage that the electric connections 23 of the electric element 21 are freely accessible from the outside. In principle, the splaying body could however also be closed at the top.

FIG. 12 and FIG. 13 illustrate a further exemplary embodiment of an element which, similarly to that of FIG. 8, comprises a predetermined installation groove area of a one-part closure disc as a head part of a tension bolt that can be pulled to provide tension. The closure disc can be splayed by an axial force in the tension bolt and can thus be pressed radially against the inner wall of the bore of the component 10 to be closed.

According to the invention a housing 20 of the electric element 21 is disposed in an opening of the closure disc, which electric element 21 is in turn shown diagrammatically. This opening for receiving the housing 20 of the electric element 21 is of such a length that it can extend below through the predetermined installation groove area and so, after the pulling back of the splaying body in the base body, a continuous opening is produced at the underside of the slaying body. The housing 20 of the electric element 21 is inserted tightly into the latter, adjacent to the chamber formed in the bore 11 towards the inside. The receiver of the electric element 21 can be positioned inside the cavity 537 or outside of it, so there may be or not electric connections leading away to the outside. A receiver or transceiver can also be positioned in the bore 537.

The invention is sufficiently demonstrated by the exemplary embodiments described above. However, it could also be disclosed by other versions. Thus, two or even more such electric elements 21 could be integrated into a closure element 110, 210, 310, 410 or 510, for example by the one electric element being integrated into the base or splaying body and the second being positioned beneath the base body, this second electric element also being able to be annular in form. The other element disposed above the latter could be cylindrical or of a similar form so that there would also be a connection to the inside of the engine etc. in order to measure e.g. with one the temperature and with the other the pressure of the medium in the chamber.

Furthermore, in the fitted state, the electric element 20 could not be directly adjacent to the chamber formed in the bore, but could for example project into the bore or into the interior of the component by means of a line with a sensor or the like.

Moreover, within the framework of the invention there is a further advantage in that the electric element 20 can be replaced if it is defective or is to be replaced by a different one. Thus, for example, the element 10 could be removed from the bore 11 by a removal device and a new element could be fitted with a new electric element 20.

Generally, the bore 11, the respective element and so also the electric element 21 is formed with a round cross-section. Theoretically however, a rectangular or polygonal cross-section could also be provided in these elements.

### List of Reference Signs

10 component
11 bore
12 upper surface of component
13 inner surface of bore
20 housing of electric element
21 electric element
22 cable
23 electric connections
30 longitudinal axis
110 closure element
120 sleeve shaped base body
121 outer surface of 120
122 inner surface of 120
123 upper surface of 120
123′ upper surface of 130
130 splaying body
131 head of 130
132 tension bolt of 130
133 installation groove area
134 outer head surface of 131
135 flat underside of 131
136 outer surface of 132
137 cavity in 130
138 bottom surface of 137
140 inner opening of 120/220
141 middle portion (smaller inner diameter)
142 inclined section
143 outer portion (larger inner diameter)
210 closure element
220 base body
225 complementary surface of base body 220
230 splaying body
231 head of 230
234 outer head surface of 231
235 rounded tapered surface
310 closure element
320 base body
330 splaying body
335 underside of 330
337 connecting cavity in 330
337′ sensor cavity in 330
338 shoulder
339 O-ring
410 closure element
420 base body
430 splaying body
435 underside of 430
437 connecting cavity in 430
510 closure element
520 base body
530 splaying body
535 underside of 530
537 blind hole cavity in 530
537′ sensor cavity in 530
538 transfer area

1-15. (canceled)

16. A closure element for inserting into a bore of a component, comprising:
a base body to be inserted into the bore of the component,
a splaying body having a longitudinal axis, an internal opening along the longitudinal axis and an upper surface,
a tension bolt having an installation element, and
an electric element arranged at least partly in the opening of the splaying body,
wherein the tension bolt is inserted through the splaying body,
wherein the electric element is configured to transmit and/or receive electric signals, wherein the splaying body braces the base body in the fitted state in said bore,
wherein the internal opening is provided with its outlet directed towards the upper surface, and
wherein the installation element is configured to be connected to an installation tool for pulling the splaying body back into the base body for fixation of the closure element in said bore.

17. The closure element according to claim 16, wherein the internal opening is a through bore, and wherein the electric element is provided inside a housing and wherein the housing is positioned in the internal opening near the underside of the splaying body.

18. The closure element according to claim 17, wherein the housing is glued in the internal opening.

19. The closure element according to claim 17, wherein the housing is fixed by injection moulding.

20. The closure element according to claim 17, wherein the through bore has a connecting cavity and a sensor cavity, and wherein the sensor cavity has a larger diameter to accommodate the housing of the electric element against the shoulder between connecting cavity and sensor cavity.

21. The closure element according to claim 20, wherein the housing comprises one or more grooves to accommodate sealing rings.

22. The closure element according to claim 16, wherein the electric element comprises two or more electric connections which are extending beyond the outlet of the internal opening.

23. The closure element according to claim 22, wherein the electric connections are provided within a cable.

24. The closure element according to claim 23, wherein the cable is a shielded cable.

25. The closure element according to claim 23, wherein the cable comprises a plug at the end opposite to the electric element.

26. The closure element according to claim 16, wherein the electric element comprises a transceiver for wireless communication.

27. The closure element according to claim 16, wherein the electric element comprises one or more sensors.

28. The closure element according to claim 16, wherein the outlet of the internal opening is oriented towards the upper surface of the tension bolt beyond the installation element of the splaying body.

29. The closure element according to claim 28, wherein the installation element comprises one or more installation grooves.

30. The closure element according to claim 16, wherein the electric element comprises a transceiver for wireless communication, wherein the internal opening comprises a connecting cavity and a sensor cavity, and wherein the sensor cavity near the underside of the splaying body accommodates the housing of the electric element and the connecting cavity at the opposite side of the splaying body is separated from the sensor cavity by a signal transfer area within the splaying body adapted to allow a wireless signal transfer through the signal transfer area and the connecting cavity.

31. The closure element according to claim 30, wherein a first NFC transceiver is positioned in the connecting cavity and wherein the electric element comprises a second NFC transceiver.

32. The closure element according to claim 30, wherein the electric element comprises a battery.

33. The closure element according to claim 30, wherein the electric element comprises one or more sensors.

34. The closure element according to claim 30, wherein the outlet of the internal opening is oriented towards the upper surface of the tension bolt beyond the installation element of the splaying body.

35. The closure element according to claim 34, wherein the installation element comprises one or more installation grooves.
